(19) United States
(12) Patent Application Publication
(10) Pub. No.: US 2024/0070876 A1
(43) Pub. Date: Feb. 29, 2024

(54) CONTROL APPARATUS, METHOD, AND NON-TRANSITORY COMPUTER-READABLE STORAGE MEDIUM

(71) Applicant: CANON KABUSHIKI KAISHA, Tokyo (JP)

(72) Inventor: YUJIRO IDAKA, Tokyo (JP)

(21) Appl. No.: 18/456,812

(22) Filed: Aug. 28, 2023

(30) Foreign Application Priority Data
Aug. 29, 2022 (JP) 2022-136233

(51) Int. Cl. G06T 7/20; G06V 10/25

(52) U.S. Cl. CPC G06T 7/20; G06V 10/25; G06V 2201/07

(57) ABSTRACT

A control apparatus includes an acceleration detection unit that detects an acceleration, and a processor and memory storing instructions that when executed by the processor, cause the control apparatus to determine a motion vector from video data within a vehicle obtained by an image capturing unit fixed in the vehicle, determine whether there is a correlation between an amount of change of a determined motion vector in a preset period and the detected acceleration in the preset period for each position in the video data, and determine, based on a result of the determination for each position, as an out-of-vehicle region, a region in which an object outside of the vehicle within the video data appears.

### BACKGROUND

### Field

The present disclosure relates to a control apparatus, a method, and a non-transitory computer readable storage medium.

### Description of the Related Art

A camera can be controlled via a network, a dedicated line, a remote controller, or the like, and video obtained by the camera can be viewed. For example, detection of theft of an object such as a painting or a bag, detection of a moving object, detection of a person, and the like can be performed using a technique of analyzing a video of a specific region or the entirety of a video acquired by a camera. Some video analysis processing technology is installed in cameras, and it is also possible to perform video analysis in cameras and output analysis results.

A technique is known in which a camera mounted inside a vehicle captures the scenery outside a vehicle window and analyzes the video to determine the movement of the vehicle (Japanese Patent Laid-Open No. 2008-42759). A method of determining whether a pattern of a motion vector of a part in a video that moves outside the vehicle matches a predetermined pattern and determining thereby whether the vehicle is moving has been proposed (Japanese Patent Laid-Open No. 2008-42759).

### SUMMARY

According to aspects of the present disclosure, it is possible to accurately detect out-of-vehicle regions in a video to identify a moving object within the vehicle. In-vehicle objects can be easily detected by excluding vectors of out-of-vehicle regions from among the motion vectors in the video.

The present disclosure provides a control apparatus comprising an acceleration detection unit configured to detect an acceleration, at least one processor, and at least one memory in communication with the at least one processor, the memory storing instructions that, when executed by the at least one processor, cause the processor to determine a motion vector from video data within a vehicle obtained by an image capturing unit fixed in the vehicle, to determine whether there is a correlation between an amount of change of a determined motion vector in a preset period and the detected acceleration in the preset period for each position in the video data, and to determine, based on a result of the determination for each position, as an out-of-vehicle region, a region in which an object outside of the vehicle within the video data appears.

The present disclosure provides a method of a control apparatus having an acceleration detection unit configured to detect an acceleration, the method comprising determining a motion vector from video data within a vehicle obtained by an image capturing unit to be fixed in the vehicle, determining whether or not there is a correlation between an amount of change of a motion vector obtained by the motion vector determination in a preset period and the acceleration obtained by the acceleration detection unit in the period for each position in the video data, and determining, as an out-of-vehicle region, a region in which an object outside of the vehicle within the video data appears, based on a result of the determination for each position.

The present disclosure provides a non-transitory computer-readable storage medium storing instructions that, when executed by a computer, cause the computer to perform a method of a control apparatus having an acceleration detection unit configured to detect an acceleration, the method comprising determining a motion vector from video data within a vehicle obtained by an image capturing unit to be fixed in the vehicle, determining whether or not there is a correlation between an amount of change of a motion vector obtained by the motion vector determination in a preset period and the acceleration obtained by the acceleration detection unit in the period for each position in the video data, and determining, as an out-of-vehicle region, a region in which an object outside of the vehicle within the video data appears, based on a result of the determination for each position.

Further features of the present disclosure will become apparent from the following description of exemplary embodiments with reference to the attached drawings.

### BRIEF DESCRIPTION OF THE DRAWINGS

FIG. 1 is a block configuration diagram of an image capturing apparatus according to an exemplary embodiment.

FIG. 2 is a view illustrating a relationship between a speed and an acceleration of a vehicle according to an exemplary embodiment.

FIG. 3 is a view illustrating an example of a video of the inside of a vehicle according to an exemplary embodiment.

FIG. 4 is a flowchart for describing details of processing according to an exemplary embodiment.

FIG. 5A is a flowchart for describing a process for determining an in-vehicle moving object in step S406 of FIG. 4.

FIG. 5B is a flowchart for describing another method of determining an in-vehicle moving object according to an exemplary embodiment.

FIG. 6A is a view illustrating an example of an acceleration sensor having a plurality of axes according to an exemplary embodiment.

FIG. 6B is a view illustrating an example of an acceleration sensor having a plurality of axes according to an exemplary embodiment.

### DESCRIPTION OF THE EMBODIMENTS

Exemplary embodiments will be described below with reference to the attached drawings. The following exemplary embodiments are not intended to be limiting. Multiple features are described in the exemplary embodiments, but all such features are not required, and multiple features can be combined as appropriate. In the attached drawings, the same reference numerals are provided for the same or similar elements, and redundant descriptions thereof are omitted.

An exemplary embodiment of the present disclosure will now be described with reference to the attached drawings.

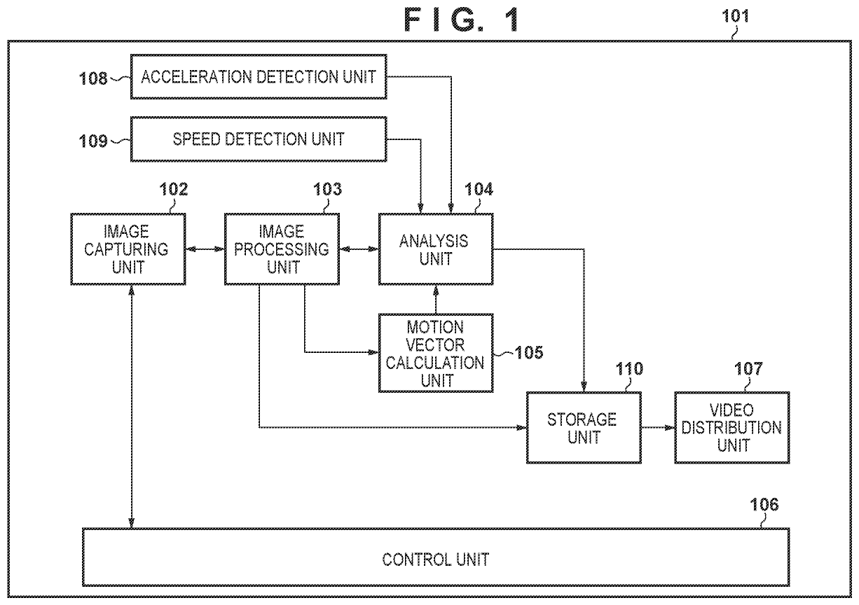

FIG. 1 is a block configuration diagram of an image capturing apparatus 101 according to an exemplary embodiment. The image capturing apparatus 101 according to the present embodiment is installed in a vehicle, which is the present embodiment is a bus for discussion purposes only, where an optical axis for image capturing is fixed. The image capturing apparatus 101 captures and records an in-vehicle video, including outside scenery viewed through a vehicle window. The image capturing apparatus 101 includes functions of communicating with a network, which includes the Internet, receiving various commands from a client device (not illustrated) on the network, performing processing based on the commands, and distributing video to the client device.

The image capturing apparatus 101 includes an image capturing unit 102, an image processing unit 103, an analysis unit 104, a motion vector calculation unit 105, a control unit 106, a video distribution unit 107, an acceleration detection unit 108, a speed detection unit 109, and a storage unit 110. The image capturing apparatus 101 also includes a display unit (not illustrated) or the like that displays a captured video.

The control unit 106 includes a ROM in which a program executed by a CPU is stored and a RAM used as a work area for the CPU. The control unit 106 is responsible for controlling the image capturing apparatus 101.

The image capturing unit 102 includes a lens, an aperture, an image sensor, and the like, captures video at 30 frames per second, for example, and supplies the obtained video data to the image processing unit 103.

The image processing unit 103 converts the video data supplied from the image capturing unit 102 into a format that is easy to display. The video data formatted by the image processing unit 103 is temporarily stored in the storage unit 110, is distributed to an external network by the video distribution unit 107 as necessary, and is distributed via a distribution route such as Ethernet or USB.

The analysis unit 104 analyzes video data that has passed through the image processing unit 103. The analysis unit 104 has a function of detecting a situation that has occurred in a user-specified region or in the entire video data by analyzing the video data. In addition, the analysis unit 104 can generate an event when a person moving in the video data or an object moving in the video data is detected. As described below, the analysis unit 104 analyzes the video data, specifies an out-of-vehicle region from motion vectors in the video, determines an in-vehicle object, and stores information indicating the determination result in the storage unit 110. The video distribution unit 107 can also externally distribute the motion vector determination result to a user terminal (not illustrated) on an external network as necessary. The user terminal can create, for example, short video data in which only an in-vehicle moving object appears from the received video using the received video and the motion vector determination result.

The motion vector calculation unit 105 has a function of detecting or calculating a motion vector corresponding to the movement of an object in the video data.

The acceleration detection unit 108 comprises an inertial sensor or an acceleration sensor, and detects acceleration related to movement of the image capturing apparatus 101. Since the image capturing apparatus 101 in the present embodiment is fixed to a vehicle as previously described, the acceleration detection unit 108 detects the acceleration of the vehicle. For explanation purposes, with respect to the acceleration detected by the acceleration detection unit 108, it is assumed that an acceleration component in the traveling direction of the vehicle is detected

The speed detection unit 109 detects a movement speed of the vehicle. The speed detection unit 109 can obtain the speed from the position in relation to time according to, for example, a GPS system. Alternatively, a signal related to speed detection performed by the vehicle can be directly inputted and the vehicle speed can be detected from the signal. The speed detection unit 109 also detects a speed component in the traveling direction of the vehicle.

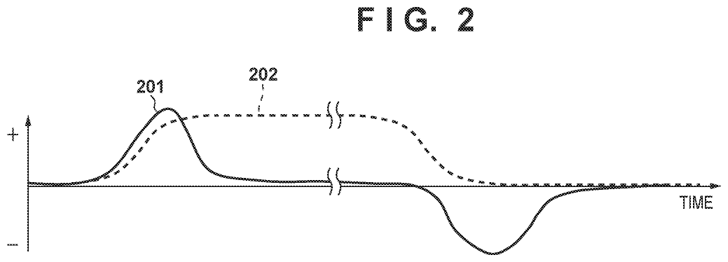

FIG. 2 illustrates a typical example in which the vehicle transitions from being stopped to accelerating, travels at a constant speed, and then decelerates and stops. Reference numeral 201 in the figure indicates acceleration information, and reference numeral 202 indicates speed information. As illustrated, if the vehicle only travels forward, the vehicle speed will be above zero and non-negative. The acceleration is positive during the period from when the vehicle is stopped to when the vehicle is traveling at a constant speed of the vehicle, zero when the vehicle is traveling at a constant speed, and a negative value from when the vehicle starts decelerating until the vehicle stops.

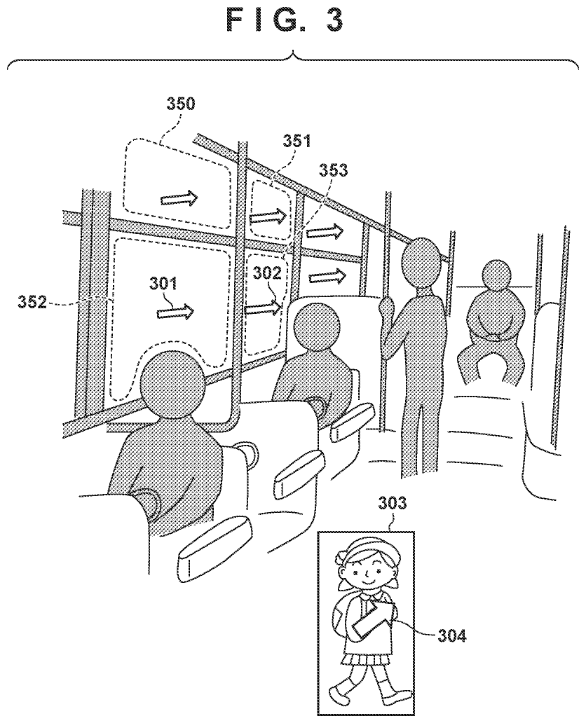

FIG. 3 is an example of an in-vehicle video captured by the image capturing apparatus 101 while the vehicle is traveling. Reference numerals 301 and 302 indicate motion vectors of objects outside the vehicle appearing in vehicle windows in the video. It is assumed that a moving object (the child 303 is moving inside the vehicle, and a reference numeral 304 indicates a movement vector thereof. In this way, motion vectors of an in-vehicle moving object and motion vectors of objects outside the vehicle are included in the video.

In the present embodiment, motion vectors of an object outside the vehicle in the video are to be excluded, and motion vectors of an in-vehicle moving object are to be detected.

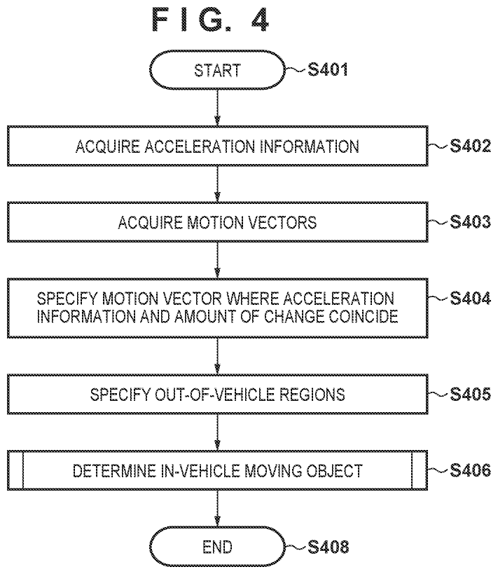

Details of processing in the present embodiment will now be described with reference to the flowchart of FIG. 4.

After the processing starts (step S401) while the vehicle is stopped, the acceleration detection unit 108 starts acquiring acceleration information (201) (step S402). The motion vector detection unit 105 acquires motion vectors in the video data (step S403).

In the video captured by the image capturing apparatus 101, when the vehicle starts moving from the stopped state, an object (a background image) outside the vehicle in the video moves, and the motion vectors 301 and 302 start to occur based on the motion vector calculation unit 105. At this time, the pattern of the amount of change (the difference between the motion vectors with respect to time) of the motion vectors 301 and 302 substantially coincides with the pattern of the acceleration information 201 detected by the acceleration detection unit 108.

When the vehicle is stopped, the acceleration information 201 is zero. When the vehicle is accelerating, the acceleration information 201 indicates a value having a high numerical value, and the amount of change in the vector amount of the motion vector 201 also increases. The acceleration information 201 then gradually approaches zero as the vehicle approaches travel at a constant speed. The “amount of change of the motion vectors 301 and 302” of objects outside the vehicle in the acceleration period from when the vehicle is stopped to when the vehicle is traveling at a constant speed also indicates the same pattern as the acceleration information 201.

When the vehicle transitions to traveling at a constant speed, the acceleration information 201 indicates a zero state, the motion vectors 301 and 302 of the object outside the vehicle become a substantially constant value (larger than zero) corresponding to the vehicle speed, and the “amount of change” of the motion vectors 301 and 302 becomes a value close to zero.

The magnitude of the motion vector 304 of the in-vehicle moving object 303 and the amount of change thereof are independent of the speed detected by the speed detection unit 109 and the acceleration detected by the acceleration detection unit 108.

As described above, the analysis unit 104 specifies a position of a motion vector having a high degree of coincidence with the pattern indicated by the acceleration information detected by the acceleration detection unit 108 from among the patterns indicated by the amount of change in motion vectors calculated by the motion vector calculation unit 105 in the video data (step S404). While an out-of-vehicle region is being specified (step S404), the control unit 106 performs a process of preferentially matching an appropriate exposure amount of the image capturing unit 102 with a candidate region of an out-of-vehicle region in which the degree of coincidence between the amount of change in the motion vector and the acceleration information is high with respect to the image capturing unit 102. This enables acquiring a motion vector with higher accuracy. At this time, optimal exposure of the image capturing unit is performed via the control unit 106.

As a result of the above-described processing, the positions of a plurality of motion vectors are specified. The analysis unit 104 determines a region indicated by the set of positions of the plurality of specified motion vectors as an out-of-vehicle region (step S405).

In the case of FIG. 3, regions indicated by reference numerals 350 to 353 indicated by broken lines and the like can be specified as out-of-vehicle regions 301. An out-of-vehicle region 301 is finalized when, for example, a pattern of the amount of change of the acceleration information 201 and a pattern of the amount of change of the motion vector, not the motion vector itself, calculated by the motion vector calculation unit 105 continue for a predetermined period of time. After an out-of-vehicle region is finalized, the out-of-vehicle region 301 in the video data continues to be held. If an out-of-vehicle region 301 has been held for a predetermined time, or if a preset condition is satisfied, the process for obtaining out-of-vehicle regions is re-executed. The latter condition includes, for example, a condition that the vehicle starts to accelerate from a stopped state, i.e., a condition that the speed becomes non-zero from 0). As a result, when a passenger sitting on a seat gets off, or the like, an out-of-vehicle region that had been hidden by the passenger can be updated.

The described specific method for determining an out-of-vehicle region is a method of determining whether there is a correlation between the acceleration data in the direction in which the vehicle is traveling detected by the acceleration detection unit 108 in a preset period and the amount of change in a motion vector at coordinates (x, y) in the same period in the video.

For description purposes, a detection cycle of the acceleration detection unit 108 is also set to 1/30 second, which is the same as the frame rate of the image capturing unit 102. When the motion vector at the coordinates (x, y) in the video at the time “t” is defined as V(x, y, t), the amount of a change dV(x, y, t) of the motion vector at the time “t” and the time “t− 1/30” can be expressed by the following equation:

dV(x,y,t)=V(x,y,t)−V(x,y,t− 1/30)

It is assumed that acceleration data in a preset time interval is a(t1) to a(tn), and the amount of a change of the motion vector during that period is dV(x, y, t1) to dV(x, y, tn).

The analysis unit 104 determines one piece of acceleration data that is representative of the acceleration data. Representative acceleration data can be a preset ranking or, for example, an acceleration with a maximum absolute value. It is assumed in the present embodiment, that a representative acceleration is a(tm) (t1≤tm≤tn). In this case, the analysis unit 104 determines the correction coefficient c according to the following Equation (1):

c=a(tm)/dV(x,y,tm) (1)

The analysis unit 104 then determines that change amounts dV(x, y, t1) to dV(x, y, tn) of the motion vectors at the coordinates (x, y) are correlated with acceleration data a(t1) to a(tn) when the condition of the following Equation (2) is satisfied using a preset positive threshold Th. That is, the analysis unit 104 determines that the coordinates (x, y) belong to an out-of-vehicle region.

Σ{a(t)−c×dV(x,y,t)}²<Th (2)

In Equation (2), Σ is the summation function for t=t1 to tn. When it is also determined what other coordinates (x, y) belong to the above-described out-of-vehicle region, a region represented by the set of the coordinates ends up being determined as an out-of-vehicle region.

After out-of-vehicle regions are determined, the analysis unit 104 performs a process of determining in-vehicle moving objects in relation to the inputted video (step S406). After the out-of-vehicle regions are determined, the control unit 106 controls the image capturing unit 102 so that an appropriate exposure is obtained for a region outside of the out-of-vehicle regions (in-vehicle region candidate).

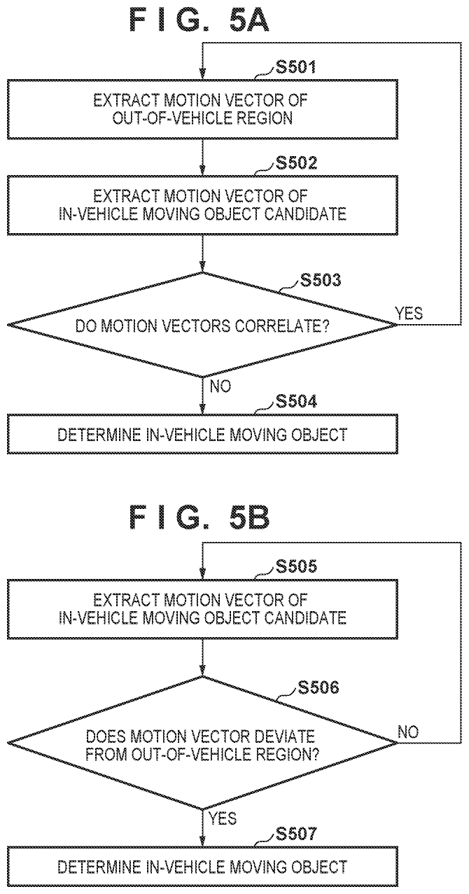

FIG. 5A is a flowchart for describing a process for determining an in-vehicle moving object in step S406 of FIG. 4.

The analysis unit 104 extracts a motion vector belonging to an out-of-vehicle region based on the coordinates of a motion vector outputted from the motion vector calculation unit 105 (step S501). Next, the analysis unit 104 extracts a motion vector that is a candidate for belonging to an in-vehicle region based on the coordinates of a motion vector outputted from the motion vector calculation unit 105 (step S502). Then, the analysis unit 194 determines whether there is a correlation between the motion vector in the out-of-vehicle region and the motion vector that is a candidate for being a moving object inside the vehicle (S503).

If it is determined that there is a correlation, the analysis unit 104 determines that the motion vector extracted in step S502 is a motion vector of an out-of-vehicle moving object and the flow returns to S501. If it is determined that there is no correlation, the analysis unit 104 determines that the motion vector extracted in step S502 is an in-vehicle moving object (step S504).

FIG. 5B is a flowchart illustrating another method of determining an in-vehicle moving object.

First, the analysis unit 104 extracts a motion vector that is a candidate for belonging to an in-vehicle region outputted from the motion vector calculation unit 105 (step S505). Then, the analysis unit 104 determines whether the extracted motion vector deviates from the out-of-vehicle region (step S506). Specifically, it is determined whether the coordinate position of the start point or the end point of the motion vector in the video deviates from the out-of-vehicle region. If the motion vector deviates from the out-of-vehicle region, the analysis unit 104 determines that the corresponding motion vector is a motion vector of an in-vehicle moving object (S507). For example, the motion vector 304 of the moving object 303 in FIG. 3 is located in a video data region that deviates from the out-of-vehicle region 301. Therefore, the object indicated by the motion vector 304 is determined to be an in-vehicle moving object. If the motion vector does not deviate, the processing returns to S506.

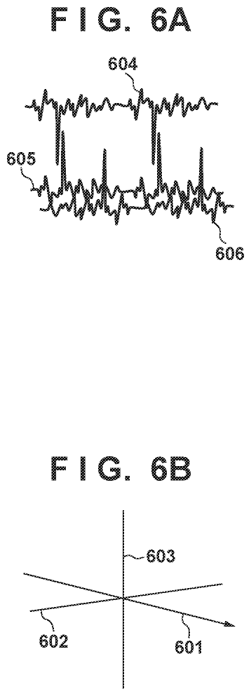

FIG. 6A and FIG. 6B are views illustrating an example of an acceleration sensor having a plurality of axes in the first embodiment. With reference to FIG. 6A and FIG. 6B, description will be provided of a case where the acceleration detection unit 108 can acquire the acceleration of a plurality of axes. As illustrated in FIG. 6B, the acceleration detection unit 108 can detect acceleration on three axes perpendicular to each other: the axis 601, the axis 602, and the axis 603. In FIG. 6A, the acceleration information of the axis 601 is indicated by reference numeral 604, the acceleration information of the axis 602 is indicated by reference numeral 605, and the acceleration information of the axis 603 is indicated by reference numeral 606. At this time, the acceleration of the axis that most coincides with the direction in which the vehicle is moving can be acquired as the acceleration most appropriately corresponding to the movement of the vehicle. In FIG. 6A, since the acceleration information 604 of the axis 601 is the largest acceleration information, the acceleration detection unit 108 outputs the acceleration information 604 as information indicating the acceleration of the vehicle.

A processing example using speed data of the speed detection unit 109 will now be described. The speed information 202 output from the speed detection unit 109 matches the magnitude of a motion vector 302 outside the vehicle in the video data. Therefore, when the speed information is used instead of using the acceleration information, it is possible to correctly determine, as an out-of-vehicle region, the out-of-vehicle region 301 by determining a video region in which the speed information 202 and the motion vector in the video coincide with each other.

While the above-described flowcharts describe the example of moving object detection for detecting a moving object in a vehicle, the present technique can be applied to video analysis techniques other than moving object detection for video analysis after specification (step S405) of an out-of-vehicle region.

As described above, according to the present embodiment, in video captured by an image capturing apparatus installed and fixed in a vehicle, a temporal pattern indicated by an amount of change in a motion vector highly correlated with acceleration information related to the travel of the vehicle is determined to belong to an out-of-vehicle region. As a result, it is possible to determine motion vectors that are not of an out-of-vehicle region as belonging to an in-vehicle moving object.

In the above-described embodiment, the amount of change in a motion vector is obtained for each of the coordinates (x, y) in the video, that is, for each pixel unit. Since resolutions of image capturing units included in image capturing apparatuses in recent years are high, it is expected that the amount of calculation will be considerable. Therefore, the analysis unit 104 can convert the image data captured by the image capturing unit 102 into a preset low resolution suitable for calculation, and then determine the above-described out-of-vehicle region. In such a case, since the determined out-of-vehicle region is of the low-resolution video, when the determined out-of-vehicle region is actually used (step S406), an in-vehicle moving object is determined by using the result of back-calculating the position and the size of the determined out-of-vehicle region in accordance with the original resolution.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these embodiments are not seen to be limiting. The scope of the following claims is to be accorded the broadest interpretation so as to encompass all such modifications and equivalent structures and functions.

This application claims the benefit of Japanese Patent Application 2022-136233, filed Aug. 29, 2022, which is hereby incorporated by reference herein in its entirety.

What is claimed is:

1. A control apparatus comprising:
an acceleration detection unit configured to detect an acceleration;
at least one processor; and
at least one memory in communication with the at least one processor, the at least one memory storing instructions that, when executed by the processor, cause the processor to:
determine a motion vector from video data within a vehicle obtained by an image capturing unit fixed in the vehicle;
determine whether there is a correlation between an amount of change of a determined motion vector in a preset period and the detected acceleration in the preset period for each position in the video data, and
determine, based on a result of the determination for each position, as an out-of-vehicle region, a region in which an object outside of the vehicle within the video data appears.

2. The control apparatus according to claim 1, wherein the processor is further caused to determine, as a motion vector of a moving object within the vehicle, a motion vector lacking correlation to a motion vector of the out-of-vehicle region from among determined motion vectors, in relation to the video data obtained by the image capturing unit.

3. The control apparatus according to claim 1, wherein the processor is further caused to determine, as a motion vector of a moving object within the vehicle, a motion vector that deviates from the out-of-vehicle region from among the determined motion vectors, in relation to the video data obtained by the image capturing unit.

4. The control apparatus according to claim 1, where the processor is further caused to control the image capturing unit to perform an appropriate exposure in relation to a region indicated by a motion vector for which it is determined that there is a correlation in the preset period.

5. The control apparatus according to claim 1, wherein the processor is further caused to store the determined out-of-vehicle region until a predetermined condition is satisfied, and to execute processing for determining a new out-of-vehicle region in a case where the predetermined condition is satisfied.

6. The control apparatus according to claim 1, wherein the process is further caused to, in a case of detecting acceleration of at least two or more different axes, output the acceleration of the axis for which an amount of change is largest in relation to a movement of the vehicle.

7. A method of a control apparatus having an acceleration detection unit configured to detect an acceleration; the method comprising:
determining a motion vector from video data within a vehicle obtained by an image capturing unit fixed in the vehicle;
determining whether there is a correlation between an amount of change of a determined motion vector in a preset period and the detected acceleration in the preset period for each position in the video data, and
determining, based on a result of the determination for each position, as an out-of-vehicle region, a region in which an object outside of the vehicle within the video data appears.

8. The method according to claim 7, further comprising determining, as a motion vector of a moving object within the vehicle, a motion vector lacking correlation to a motion vector of the out-of-vehicle region from among determined motion vectors, in relation to the video data obtained by the image capturing unit.

9. The method according to claim 7, further comprising determining, as a motion vector of a moving object within the vehicle, a motion vector that deviates from the out-of-vehicle region from among the determined motion vectors, in relation to the video data obtained by the image capturing unit.

10. The method according to claim 7, further comprising controlling the image capturing unit to perform an appropriate exposure in relation to a region indicated by a motion vector for which it is determined that there is a correlation in the preset period.

11. The method according to claim 7, further comprising storing the determined out-of-vehicle region until a predetermined condition is satisfied, and executing processing for determining a new out-of-vehicle region in a case where the predetermined condition is satisfied.

12. The method according to claim 7, further comprising causing, in a case of detecting acceleration of at least two or more different axes, outputting the acceleration of the axis for which an amount of change is largest in relation to a movement of the vehicle.

13. A non-transitory computer-readable storage medium storing instructions that, when executed by a computer, cause the computer to perform a method of a control apparatus having an acceleration detection unit configured to detect an acceleration; the method comprising:
determining a motion vector from video data within a vehicle obtained by an image capturing unit fixed in the vehicle;
determining whether there is a correlation between an amount of change of a determined motion vector in a preset period and the detected acceleration in the preset period for each position in the video data, and
determining, based on a result of the determination for each position, as an out-of-vehicle region, a region in which an object outside of the vehicle within the video data appears.
